(19) United States
(12) Patent Application Publication
(10) Pub. No.: US 2002/0069319 A1
(43) Pub. Date: Jun. 6, 2002

(54) Method and apparatus of event-driven based refresh for high performance memory controller

(76) Inventors: Ming-Hsien Lee, Hsin Chu (TW); Yi-Kang Wu, Ta Chung (TW); Chih-Chiang Wen, Hsin Chu (TW)

Correspondence Address: MARTINE PENILLA & KIM, LLP, 710 Lakeway Drive, Suite 170, Sunnyvale, CA, 94086, US

(21) Appl. No.: 09/728,066

(22) Filed: Dec. 1, 2000

(51) Int. Cl. G06F 12/00

(52) U.S. Cl. 711/106

(57) ABSTRACT

A method and apparatus for refreshing dynamic memory is provided. The apparatus includes an ahead refresh controller having an ahead queue for refreshing dynamic random access memory (DRAM) when the memory request bus is idle. In such a way that no dynamic RAM bandwidth is wasted. The apparatus also comprises a normal refresh controller having a normal queue. Giving the normal refresh request in the normal priority unless the normal queue is full. The present invention allows the refresh cycles to gather on the basis of events to minimize the overheads. In other words, even when the system is running in peak performance, the normal refresh controller can largely compact the refresh cycles by means of the normal queue to decrease occurrence of interruption.

### BACKGROUND OF THE INVENTION

A. Field of the Invention

The present invention relates to a memory controller for controlling the refresh of dynamic RAM, which comprise the system memory. More particularly, the present invention relates to an ahead refresh controller, which enhances system memory performance by performing ahead refresh cycles primarily when the request bus and DRAM bus are all idle for a predefined period and in certain condition.

B. Description of the Related Art

First, basic commands issued to DRAM are introduced before the illustration of FIG. 1. They are initial, activate, read, write, pre-charge and refresh command respectively. The initial command including PALL (pre-charge all banks), two refreshes at least and MRS (mode register set) commands, which are use to initialize DRAM and define how the device operates. After initialization, all banks of DRAM are in the idle state. Then an activate command with respect to a specified row in one bank must be issued before a read/write command is executed to the row. The activate command moves the data in the activating row to sense amplifiers. Such access is called the row-start cycle. The bank of the activated row is now in the activated state, and the subsequent read/write commands to the activated row don't need to issue further activate commands. The access cycle herein is denoted as page-hit. If the access row is different from the activated row in the same bank, a pre-charge command must be issued first to the accessed bank to move the data in the sense amplifiers back to the preactivated row and then another activate command must be issued to that bank. It forced the being accessed bank into the idle state. The access herein that issuing pre-charge and activate commands before executing a read/write command is called the page-miss cycle. The read and write concepts in DRAM are depicted in FIG. 2.

Regarding to refresh command, it is divided into two categories according to the signal CKE (clock enable). If CKE asserts, the auto refresh command is issued; otherwise, the self refresh commend is issued. Before executing the refresh command, all banks in DRAM must be in the idle state. Thus, PALL commands are usually issued before refresh commands. And the subsequent read/write requests are row-start cycles that need to issue activate commands in advance.

One of the dynamic RAM performance degradation sources is the unavoidable refresh requirement of the memory, since before executing the refresh command, all banks in DRAM must be in the idle state. Therefore, any access to the memory must be interrupted in order to perform refresh. Because of the data in dynamic RAM are stored in capacitors via charging or discharging and there is the effect of current leakage in capacitors in course of time, periodic refreshes are required and given the highest priority to remain the integrity of the stored data. The refresh frequency depends on the technology used to manufacture the memory. Reading or writing a memory cell has the effect of refresh the selected cell as well. Unfortunately, not all cells are read or written within the refresh time-limit. Thus, each cell of the dynamic RAM must be accessed and restored during the refresh interval. In most cases, refresh cycles comprising restoring the charge along an entire row. Over the course of the entire interval, every row is accessed and restored. In other word, a refresh operation must be executed for every row in the dynamic RAM and at appropriate frequency. For example, the exemplary dynamic RAM with 4096 rows will require 4096 refreshes in 64 milliseconds.

The PALL (pre-charge all banks) commands are usually issued before refresh commands to interrupt the data access of memory, and subsequent read/write requests are row-start cycles that need to issue active commands after the refresh accomplishment. Meanwhile, such refresh request shares the same request bus 15 with other read/write agents 13. Thus refresh may interrupt access requests to dynamic RAM 11. Therefore, any request of data stored in the memory must be stalled in order to perform refresh. Accordingly, it degrades the memory performance.

### SUMMARY OF THE INVENTION

It is an object of the present invention to provide an ahead refresh controller, which issues continuously auto refresh commands whenever the request bus of the dynamic RAM is idle and an ahead queue is not full. This reduces the amount of PALL and activate commands and prevents memory accesses from suffering interruption.

This invented scheme incorporates one event generator that requests to dynamic RAM bus and performs auto refresh command whenever the request bus is idle for a predefined time and in certain conditions. Such refreshes are accomplished ahead of the scheduled refresh cycles, and the count of executed refreshes is stored in an ahead queue for a record that the next refresh scheduled by normal refresh controller is no need at all. The memory refresh controller according to the invention comprises an ahead queue. Thus, it has the refresh cycles packed together and increases the bandwidth.

The present invention solves the drawback of the prior art outlined above by providing a method and apparatus to perform ahead refreshes on dynamic RAM prior to the normal refreshes during the periods when request bus and DRAM bus are idle for a predefined interval.

The method and apparatus of the present invention comprises an ahead refresh controller having an ahead queue, a normal refresh controller with programmable depth, a memory controller, a finite state machine (FSM), a bus monitor, and a bus arbiter. The period of executed ahead refresh requests is much shorter than the normal refreshes period.

### BRIEF DESCRIPTION OF THE DRAWINGS

These and other objects and advantages of the present invention will become apparent by reference to the following description and accompanying drawings wherein:

FIG. 1 depicts a functional block diagram of the prior art regarding a memory access system with normal refreshes;

FIG. 2 depicts the read and write concepts in dynamic RAM;

FIG. 3A depicts a functional block diagram of the invention; shows a memory access system with augmented ahead refresh controller and ahead queue;

FIG. 3B depicts a functional block diagram of the invention; shows a memory access system with augmented ahead refresh controller, ahead queue, and normal queue with programmable queue depth;

FIG. 4A is a flow chart depicting a method performed by the ahead refresh controller without normal queue;

FIG. 4B is a flow chart depicting a method performed by the normal refresh controller without normal queue;

FIG. 5A is a flow chart depicting a method performed by the ahead refresh controller with ahead queue;

FIG. 5B is a flow chart depicting a method performed by the normal refresh controller with normal queue;

FIG. 5C is a flow chart depicting refresh requests generated by non-empty normal queue;

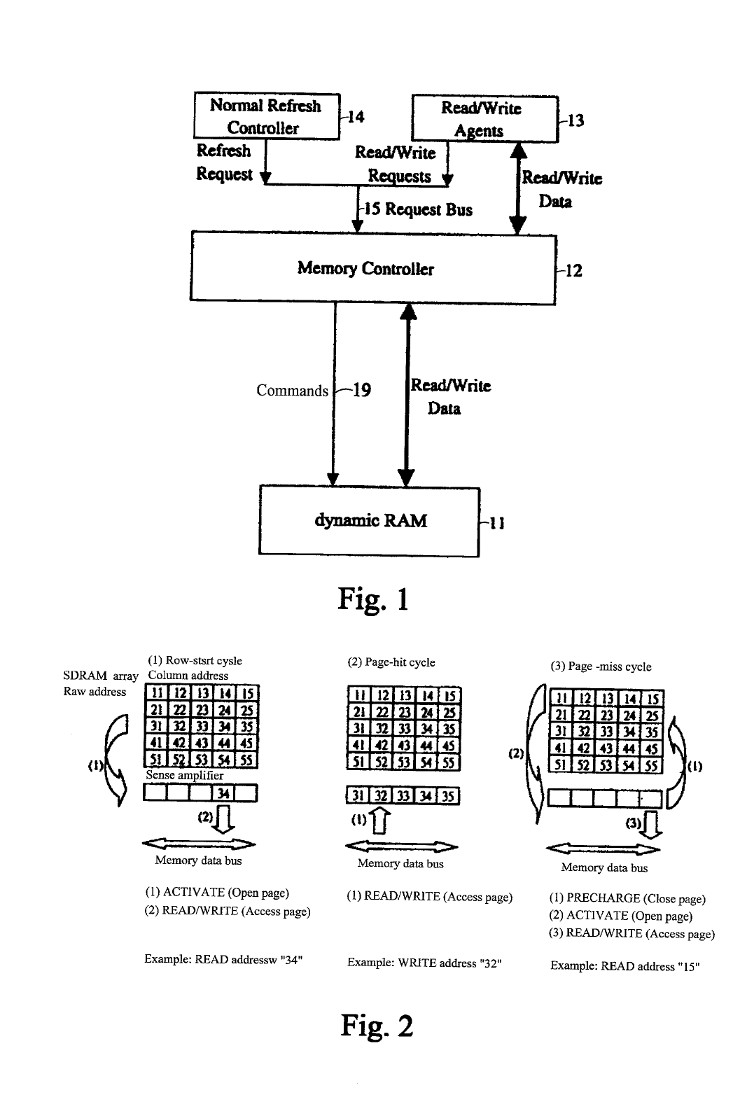

### DETAIL DESCRIPTION OF THE INVENTION

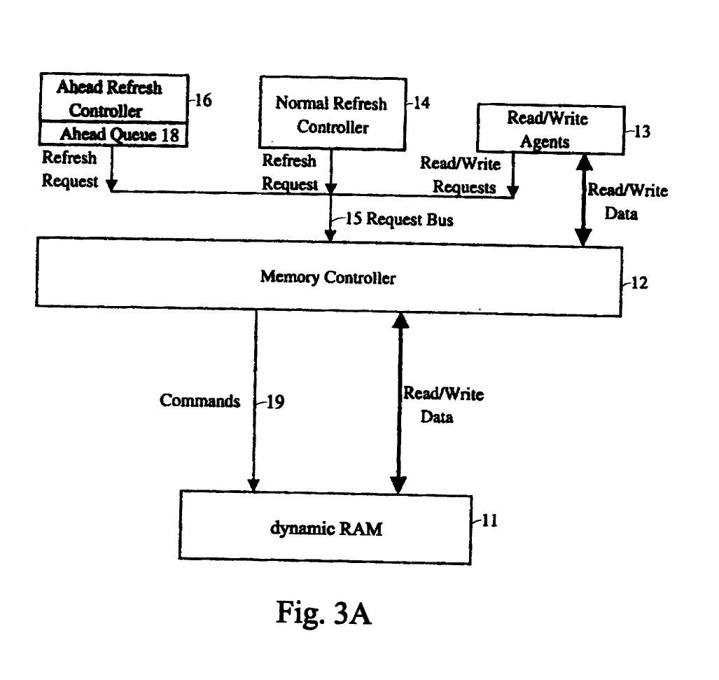

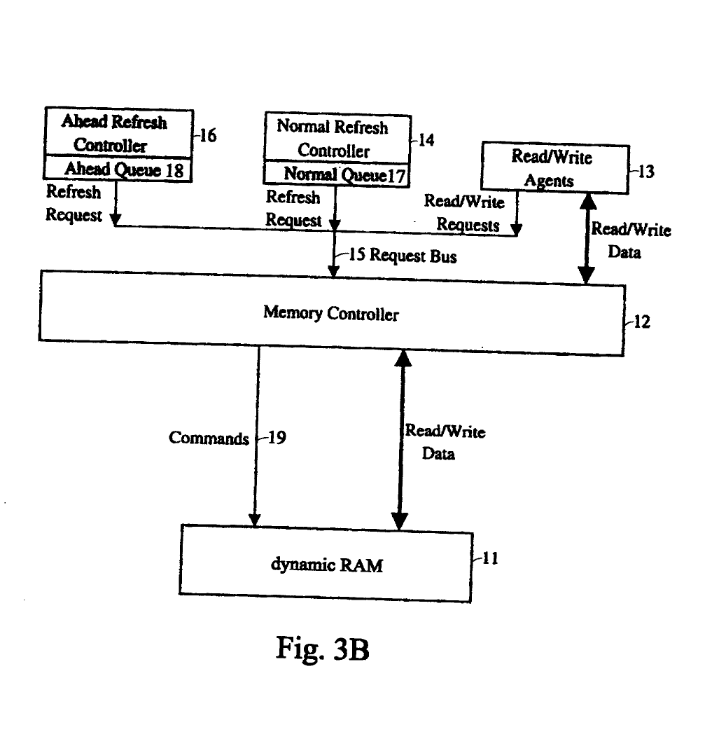

FIG. 3A illustrates a memory system according to the present invention. The memory system comprises a memory controller 12, an ahead refresh controller 16, a normal refresh controller 14, read/write agents and dynamic RAM (system memory) 11. The ahead refresh controller 16 and normal refresh controller 14 are connected to the memory controller 12 via a request bus 15. Meanwhile the read/write agents are coupled to the memory controller 12 via the request bus and a data bus. The DRAM is coupled to the memory controller 12 via the address bus, data bus and command bus 19. The command bus 19 preferably comprising various control lines including CAS, RAS, and write enable WE. The ahead refresh controller 16 has an ahead queue 18 to count the ahead refresh command issued prior to the normal refresh command.

In the present invention, the ahead refresh controller 16 is employed to issue ahead refresh command to reduce the performance penalty of refreshes needed in dynamic RAM as depicted in FIG. 3. Substantially, the ahead refresh controller 16 performs refresh requests prior to the normal refresh controller 14, whenever the request bus 15 and the command bus 19 are idle for a period of time. The ahead queue 18 keeps the count of executed refreshes by the ahead refresh controller 16, wherein the ahead refreshes period is much shorter than the normal refreshes period.

From the above description, the present invention gathers the refresh cycles together on the basis of events to minimize the unavoidable refresh overheads. Particularly, the ahead refresh controller gets the chance that the request bus and command bus are all idle for a predefined interval to perform ahead refreshes, such that no dynamic RAM bandwidth is wasted. In the mean time, the normal refresh controller can still largely compact the refresh cycles by means of a nonempty normal queue whose depth is programmable to decrease occurrences of memory access interruption, as depicted in FIG. 3B.

[First Embodiment]

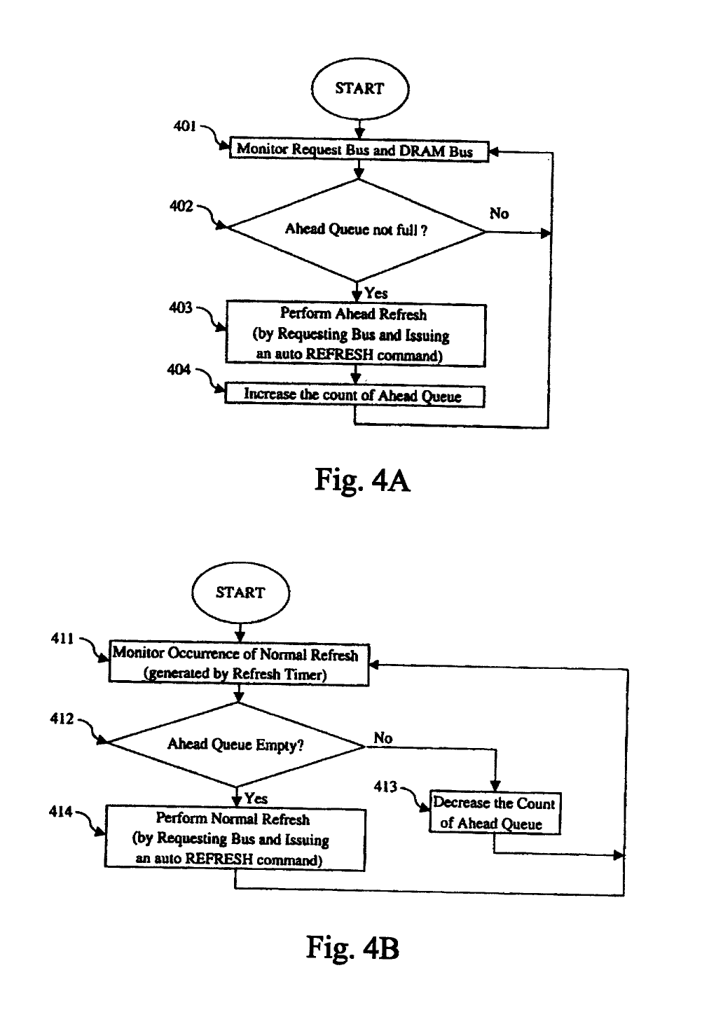

The control flow of the embodiment according to the present invention is illustrated with reference to FIG. 4A and FIG. 4B. After the dynamic RAM being initialized successfully (is not shown), the process of ahead refresh controller 16 and the normal refresh controller 14 follows the flowcharts.

FIG. 4A shows the control flow of the ahead refresh controller 16 according to the present invention, which illustrates the process for the ahead refresh controller 16 having the ahead queue 18. The control flow includes the following steps:

Step 401: monitor the request bus 15 and the command bus 19 of the memory by bus monitor to initiate the ahead refresh; if the request bus 15 and the command bus 19 are both idle, jump to step 402, otherwise repeat this step.

Step 402: examine whether the ahead queue 18 is full; if the ahead queue 18 is full, then jump to step 401, otherwise jump to step 403.

Step 403: request the memory bus and issue an auto refresh command when grants the memory bus.

Step 404: increase the count of the ahead queue 18, in response to the completion of ahead refreshes and then jump back to step 401.

FIG. 4B shows the control flow of normal refresh controller 14 according to the present invention. The control flow includes the following steps:

Step 411: generate normal refresh request at every normal refresh period Tn periodically.

Step 412: examine whether the ahead queue 18 is empty; jump to step 414 if the ahead queue 18 is empty, otherwise jump to step 413.

Step 413: decrease the count of the ahead queue 18 and then jump back to step 411.

Step 414: request the memory bus and issue an auto refresh command when grants the memory bus, then jump back to step 411.

The counting of the ahead queue 18 of the ahead refresh controller 16 is increased to denote the number of how many ahead refreshes have been performed. The count setting of the ahead queue 18 will change the period of the normal refresh period Tn. Generally, the normal refresh period Tn in prior art equals to the memory refresh period, such as 64 ms, divided into the total rows, such as 4096, of the dynamic RAM, so the Tn is about 15.6 us. However, the normal refresh period Tn of the present invention will be shorter than that in prior art. According to the present invention, the normal refresh period Tn equals to the memory refresh period, such as 64 ms, divided into the total rows, such as 4096, of the dynamic RAM and the count setting, such as 32, of the ahead queue 18. For example, if memory refresh period is 64 ms, the total rows of the dynamic RAM is 4096, and the count setting of the ahead queue 18 is 32, then the Tn is about 15.5 us (64 ms/(4096+32)). It is noted that since the normal refresh period Tn also considers the count setting of the ahead queue 18, the maximum period of refresh cycle for the dynamic RAM will be controlled under 64 ms.

According to the flowchart of FIG. 4B, the normal refresh controller 14 issues auto refresh commands only when the ahead queue 18 is empty. It means that if the memory bus request is not always busy, the ahead refresh controller 16 will issue ahead refresh command when the system memory is idle. Therefore, the normal refresh controller 14 will skip some normal refresh commands which is issued by the ahead refresh controller 16, with the result that the memory performance is increased.

[Second Embodiment]

In the first embodiment, the normal refresh controller 14 must have the highest request priority to grant the memory bus to issue the normal refresh command when the ahead queue 18 is empty. But in the second embodiment, not only the ahead refresh controller employees the ahead queue 18 but the normal refresh controller 14 also employees a normal queue 17, as shown in FIG. 3B. The normal refresh controller 14 owns the normal bus request priority to grant the memory bus when the normal queue 17 is not full. However, when the normal queue 17 is full, the bus request priority is promoted to the highest priority to grant the memory bus to issue the refresh command. Such that, the normal refresh controller 14 will reduce the interrupts of the memory bus which are being requested by other read/write agents.

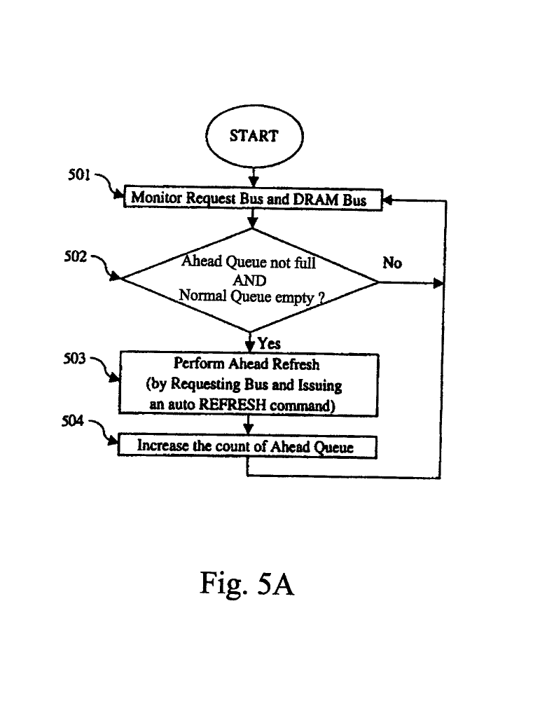

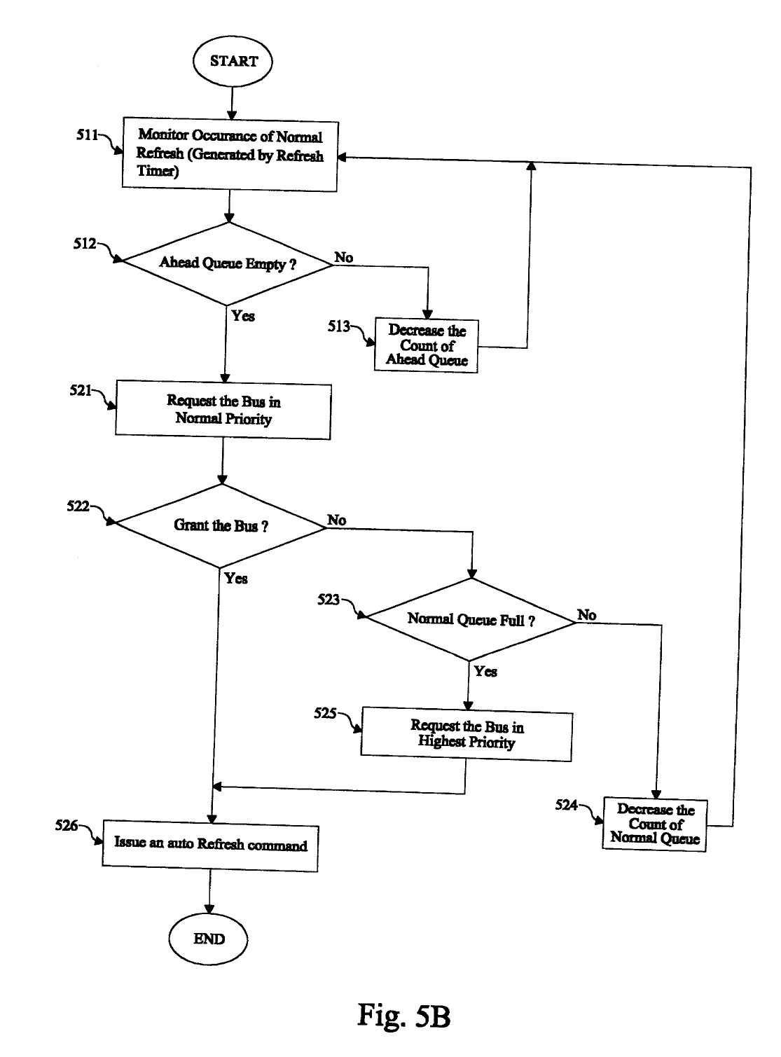

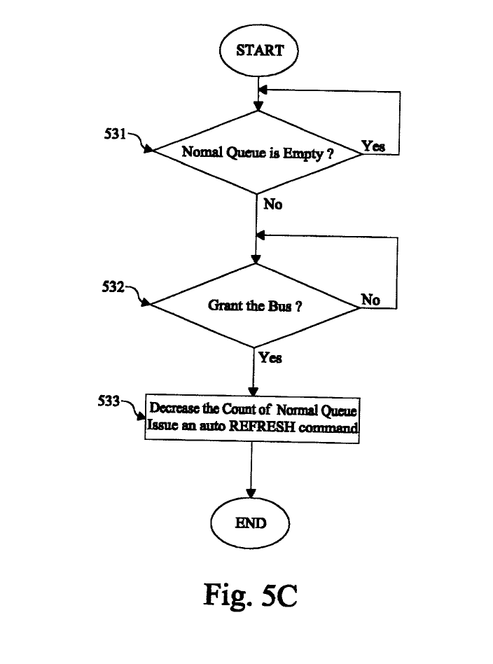

FIG. 5A illustrates the flowchart of the ahead refresh controller 16 of the second embodiment. The difference of the flowchart of the ahead refresh controller 16 between the first embodiment and the second embodiment is when to issue an ahead refresh command. The ahead refresh controller 16 in first embodiment issues the ahead refresh command when the ahead queue 18 is not full, but the refresh controller 16 in second embodiment issues the ahead refresh command when the ahead queue 18 is not full and the normal queue 17 is empty. Therefore, the detail description of the flowchart about the ahead refresh controller 16 in this embodiment is omitted.

FIG. 5B shows the control flows of the normal refresh controller 14 with the normal queue 17 and FIG. 5C shows the control flow of the normal refresh controller 14 when the normal queue 17 is not empty. Referring to FIG. 5B, it shows the control flows of the normal refresh controller 14 of this embodiment according to the present invention. The control flows includes the following steps:

Step 511: generate normal refreshes by a refresh timer.

Step 512: examine whether the ahead queue 18 is empty; if the ahead queue 18 is not empty, jump to step 513, otherwise normal jump to step 521.

Step 513: decrease the count of the ahead queue 18 and jump back to the step 511.

Step 521: request the memory bus in normal priority.

Step 522: examine whether the normal refresh controller 14 grants the bus; if the normal refresh controller 14 grants the bus, jump to the step 526, otherwise jump to the step 523.

Step 523: examine whether the normal queue 17 is full; if the normal queue 17 is full, jump to the step 525, otherwise jump to the step 524.

Step 524: increase the count of the normal queue 17 and jump back to step 511.

Step 525: promot the normally bus request priority to the highest bus request priority, grant the memory bus and jump to step 526.

Step 526: issue the normal refresh command and jump back to step 511.

Moreover, as depicted in FIG. 5C, if the normal queue 17 is not empty, the normal refresh controller 14 will continuously request the memory bus at normal bus request priority and issue refresh command if it grants the memory bus. The controlling steps are followings:

Step 531: examine whether the normal queue 17 is empty; if the normal queue 17 is empty, repeat this step, otherwise jump to the step 532.

Step 532: examine whether the normal refresh controller 14 grants the memory bus at normal priority; if the normal refresh controller 14 grants the memory bus, jump to the step 533, otherwise jump to the step 531;

Step 533: issue an auto refresh command, decrease the count of normal queue 17 and jump back to step 531.

As shown in FIG. 5A and 5B, the normal refresh controller 14 does not always issue a refresh command immediately when the ahead queue 18 is empty, but increases the count of the normal queue 17 when the normal refresh controller 14 does not grant the memory bus at normal bus request priority. Then, if the normal queue is not empty, the normal refresh controller 14 will continuously requests the memory bus at the normal bus request priority and issue a refresh command immediately when grants the memory bus. Therefore, the queue of the normal refresh controller can reduce the interrupts of the memory bus and increase the performance of the system memory.

It should be understood that various alternatives to the structures described herein may be employed in practicing the present invention. It is intended that the following claims define the invention and that the structure within the scope of these claims and their equivalents be covered thereby.

While this invention has been described with reference to an illustrative embodiment, this description is not intended to be construed in a limiting sense. Various modifications and combinations of the illustrative embodiment, as well as other embodiments of the invention, will be apparent to persons skilled in the art upon reference to the description. It is therefore intended that the appended claims encompass any such modifications or embodiments.

What is claimed is:

1. An Event-Driven Based Refresh method for refresh a dynamic RAM, comprising the steps of:
monitoring the request bus of said dynamic RAM;
issuing an ahead refresh command whenever said dynamic RAM is idle for a predefined period and an ahead queue is not full;
increasing the count of said ahead queue whenever an ahead refresh command is issued;
issuing a normal refresh command at every normal refresh period Tn periodically when said ahead queue is empty; and,
decreasing the count of said ahead queue at every said normal refresh period Tn periodically when said ahead queue is not empty.

2. The Event-Driven Based Refresh method of claim 1, wherein said normal refresh period Tn equals to the memory refresh cycle time divided into the sum of total rows of said dynamic RAM and the predetermined count setting of the ahead queue.

3. An Event-Driven Based Refresh method for refresh a dynamic RAM, comprising the steps of:
monitoring the request bus of said dynamic RAM;
issuing an ahead refresh command whenever said dynamic RAM is idle for a predefined period, an ahead queue is not full and a normal queue is empty;
increasing the count of said ahead queue whenever an ahead refresh command is issued;
requesting the memory bus in normal bus request priority when said ahead queue is empty at very normal refresh period Tn periodically;
issuing a normal refresh command when grants the memory bus;
increasing the count of said normal queue when not grants the memory bus and said normal queue is not full and said ahead queue is empty;
requesting the memory bus in highest bus request priority and issuing a normal refresh command when said normal queue is full; and,
decreasing the count of said ahead queue every said normal refresh period Tn periodically when said ahead queue is not empty.

4. The Event-Driven Based Refresh method of claim 3, further comprising the steps of:
requesting the memory bus in normal bus request priority when said normal queue in not empty;
issuing a normal refresh command and decreasing the count of said normal queue when grant the memory bus.

5. A dynamic RAM refresh controller for controlling the refresh of a dynamic RAM efficiently, comprising:
an ahead refresh controller having an ahead queue; and,
a normal refresh controller for issuing a refresh command at every normal refresh period Tn periodically when said ahead queue is empty and decreasing count of said ahead queue at every said normal refresh period Tn periodically when said ahead queue is not empty;
whereby said ahead refresh controller issues an ahead refresh command and increasing the count of said ahead queue whenever memory request of said dynamic RAM is idle for a predefined period and said ahead queue is not full.

6. The dynamic RAM refresh controller of claim 5 wherein the ahead queue is implemented by a counter.

7. The dynamic RAM refresh controller of claim 5, wherein said normal refresh controller comprises a normal queue.

8. The dynamic RAM refresh controller of claim 7 wherein the normal queue has a programmable depth and is implemented by a counter.

9. The dynamic RAM refresh controller of claim 5 wherein a bus arbiter can promote the normal refresh requests in highest priority whenever the normal queue is full.
